(19) United States
(12) Patent Application Publication
(10) Pub. No.: US 2016/0259580 A1
(43) Pub. Date: Sep. 8, 2016

(54) STORAGE CONTROL DEVICE, STORAGE CONTROL METHOD AND STORAGE CONTROL PROGRAM

(71) Applicant: FUJITSU LIMITED, Kawasaki-shi (JP)

(72) Inventors: Chikashi Maeda, Kawasaki (JP); Kazuhiko IKEUCHI, Kawasaki (JP); Kazuhiro URATA, Kawasaki (JP); Yukari Tsuchiyama, Kawasaki (JP); Takeshi WATANABE, Kawasaki (JP); Guangyu ZHOU, Kawasaki (JP)

(73) Assignee: FUJITSU LIMITED, Kawasaki-shi (JP)

(21) Appl. No.: 15/019,276

(22) Filed: Feb. 9, 2016

(30) Foreign Application Priority Data
Mar. 3, 2015 (JP) 2015-041063

(51) Int. Cl. G06F 3/06

(52) U.S. Cl. CPC G06F 3/0619; G06F 3/0644; G06F 3/0659; G06F 3/0689

(57) ABSTRACT

A storage control device includes a control unit that calculates a stripe depth and a size of padding data, when writing target data is distributed and written to respective data storages of a storage device with a RAID configuration, based on a size of the writing target data and a number of the data storages in response to a writing request to a volume on the storage device, and writes the writing target data based on the calculated stripe depth and the calculated size of the padding data.

### CROSS-REFERENCE TO RELATED APPLICATION

This application is based upon and claims the benefit of priority of the prior Japanese Patent Application No. 2015-041063, filed on Mar. 3, 2015, the entire contents of which are incorporated herein by reference.

### FIELD

The embodiment discussed herein is related to a storage control device, a control method, and a control program.

### BACKGROUND

In recent years, applications for storing files having a large size such as images, sound, and moving images in a disk array device in a large volume have increased. In such applications, there is a high demand for efficient use of disk capacity, and a redundant arrays of inexpensive disks (RAID) level using parity, such as RAID 5 or 6, is more preferably employed than RAID 1 in which capacity efficiency is 50%. On the other hand, in a case of a RAID level using parity, if a size to be written to a disk does not match a stripe size, reading from the disk, called as a write penalty (WP), occurs in order to generate parity.

As the related art, for example, there is a technique of continuously writing data into a stripe on a disk by using a main memory and a disk device without using a dedicated nonvolatile memory. In addition, there is a technique in which, when a plurality of commands which are sequentially sent from a host are requests for accessing a single consecutive region, the plurality of commands are grouped into a single command, and the single command is converted into a command for each disk device. Japanese Laid-open Patent Publication Nos. 2002-207572 and 5-289818 are examples of the related art.

However, according to the related art, in a case of a RAID level using parity, writing performance deteriorates due to a write penalty generated during writing of data into a volume to which a frequent request for sequential input/output (I/O) is made.

In one aspect, an object of the embodiment is to provide a storage control device, a storage control method, and a storage control program capable of minimizing deterioration in writing performance by reducing a write penalty.

### SUMMARY

According to an aspect of the invention, a storage control device includes a control unit that calculates a stripe depth and a size of padding data, when writing target data is distributed and written to respective data storages of a storage device with a RAID configuration, based on a size of the writing target data and a number of the data storages in response to a writing request to a volume on the storage device, and writes the writing target data based on the calculated stripe depth and the calculated size of the padding data.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating one Example of a control method according to an embodiment;

FIG. 2 is a block diagram illustrating a hardware configuration of a storage system;

FIG. 3 is a diagram illustrating a layout example of a RAID group on a physical disk;

FIG. 4 is a diagram illustrating a data structure example of a metadata entry #j;

FIG. 5 is a block diagram illustrating a functional configuration example of a storage control device;

FIG. 6 is a diagram illustrating a first processing example for a writing request;

FIG. 7 is a diagram (first) illustrating an example of setting the metadata entry #j;

FIG. 8 is a diagram illustrating an example of a disk image of an HDD 1 to an HDD 6;

FIG. 9 is a diagram illustrating a second processing example for a writing request;

FIG. 10 is a diagram (second) illustrating an example of setting the metadata entry #j;

FIG. 11 is a diagram illustrating an example of a disk image of the HDD 1 to the HDD 6;

FIG. 12 is a diagram (third) illustrating an example of setting the metadata entry #j;

FIG. 13 is a diagram illustrating a third processing example for a writing request;

FIG. 14 is a diagram (fourth) illustrating an example of setting the metadata entry #j;

FIG. 15 is a diagram (fifth) illustrating an example of setting the metadata entry #j;

FIG. 16 is a diagram illustrating correspondence between a physical address and a logical address;

FIG. 17 is a diagram (sixth) illustrating an example of setting the metadata entry #j;

FIG. 18 is a flowchart (first) illustrating an example of a writing process procedure in the storage control device;

FIG. 19 is a flowchart (second) illustrating an example of a writing process procedure in the storage control device;

FIG. 20 is a flowchart (third) illustrating an example of a writing process procedure in the storage control device;

FIG. 21 is a flowchart illustrating an example of a reading process procedure in the storage control device; and

FIG. 22 is a flowchart illustrating an example of a stripe depth readjustment process procedure in the storage control device.

### DESCRIPTION OF EMBODIMENT

Hereinafter, with reference to the drawings, a storage control device, a control method, and a control program according to an embodiment will be described in detail.

### One Example of Control Method

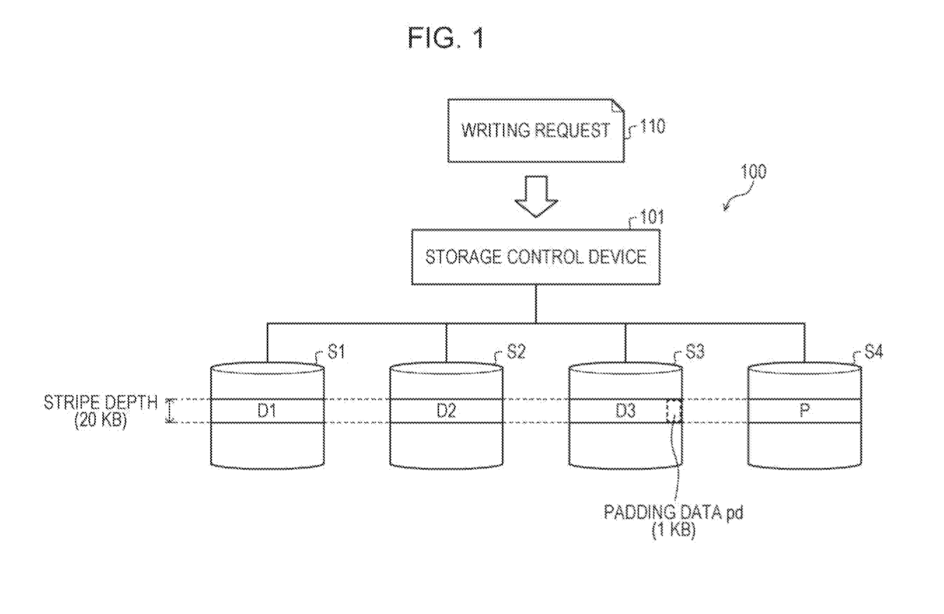

FIG. 1 is a diagram illustrating one Example of a control method of the embodiment. In FIG. 1, a storage system 100 includes a storage control device 101 and storage devices S1 to S4. The storage control device 101 is a computer controlling the storage devices S1 to S4. The storage devices S1 to S4 are storage devices storing data. The storage devices S1 to S4 include, for example, storage media such as hard disks, optical discs, and flash memories.

The storage devices S1 to S4 have a RAID configuration of applying redundancy to data with RAID 5 or 6 and storing the data. Volumes created on the storage devices S1 to S4 are, for example, volumes to which a frequent request for sequential I/O is made. For example, data with a relatively large block size, such as images, sound, and moving images, is stored in the volumes.

Here, in a case of a RAID level using parity, such as RAID 5 or 6, if a size of data to be written to a disk does not match a stripe size, reading from the disk called a write penalty (WP) occurs in order to generate parity. The stripe size indicates a capacity obtained by removing parity from a stripe set.

The stripe set is all configurations of data which is read from and written to a disk in a distribution manner through striping. In other words, if a write penalty is generated during writing of data into a volume, reading of data from the disk occurs, and thus writing performance regarding sequential I/O deteriorates.

Therefore, in the present embodiment, a description will be made of a control method of minimizing deterioration in writing performance by reducing a write penalty which is generated during writing data into a volume with a RAID level using parity in relation to a volume to which a frequent request for sequential I/O is made. Hereinafter, a processing example in the storage control device 101 will be described. Herein, it is assumed that a storage device with RAID 5(3+1) is built by using the storage devices S1 to S4.

(1) The storage control device 101 receives a writing request to volumes on the storage devices S1 to S4 with the RAID configuration. Specifically, for example, the storage control device 101 receives a writing request to the volumes from a higher-rank device such as a business server.

The writing request includes, for example, writing target data, and information (for example, a start physical address of a writing request range, and a size of the writing target data) regarding the writing request range which is a writing destination of the writing target data. In the example illustrated in FIG. 1, it is assumed that a writing request 110 for writing target data with a size of “59 KB” is received. Here, KB denotes kilo-byte.

(2) The storage control device 101 calculates a stripe depth and a size of padding data obtained when the writing target data is distributed and is written to respective data storages based on the size of the writing target data and the number of data storages. Here, the data storage is a storage medium which stores data causing parity to be generated. As the data storage, for example, a hard disk drive (HDD) or a solid state drive (SSD) may be used. Herein, as an example, a description will be made of a case of using a data disk such as an HDD as the data storage.

The stripe depth (a depth of a stripe) is a size of each data item written to each data disk in a distributed manner through striping, and is a size of a region (strip) storing data per disk in one stripe. In other words, the stripe depth corresponds to a strip size (the number of blocks inside the strip). In the stripe, all strips have the same number of blocks. In RAID of the related art, the stripe depth is set in advance and is fixed, but is calculated on each occasion based on a size of the data to be written in the present embodiment.

The padding data is dummy data for adjustment given to the writing target data in order to match a size to be written with a stripe boundary (stripe size). Specifically, for example, the storage control device 101 calculates a stripe depth and a size of padding data so that “a size of writing target data+a size of padding data” matches “the number of data disks×a stripe depth”.

In the example illustrated in FIG. 1, first, the storage control device 101 calculates the remainder obtained by dividing the size “59 KB” of the writing target data by the number of data disks “3”. Here, the remainder is “2 KB”. Next, the storage control device 101 calculates a size of “1 KB” of the padding data by subtracting the calculated remainder “2 KB” from the number of data disks “3”.

The storage control device 101 divides a value “60 KB” obtained by adding the size “1 KB” of the padding data to the size “59 KB” of the writing target data, by the number of data disks “3”, so as to calculate a stripe depth of “20 KB”. In a case where the remainder is “0”, adjustment dummy data does not have to be added to the writing target data. For this reason, a size of the padding data when the remainder is “0” is “0”.

(3) The storage control device 101 writes the writing target data based on the calculated stripe depth and size of the padding data. Specifically, for example, first, the storage control device 101 attaches padding data pd corresponding to the calculated size “1 KB” to the end of the writing target data.

Next, the storage control device 101 divides the writing target data attached with the padding data pd in the unit of the calculated stripe depth “20 KB”, and generates parity data P from separate data groups D1 to D3. The storage control device 101 distributes and writes the separate data groups D1 to D3 and the generated parity data P to the storage devices S1 to S4.

As mentioned above, according to the storage control device 101, it is possible to calculate a stripe depth and a size of padding data based on a size of writing target data and the number of data disks in response to a writing request to a volume with a RAID level using parity. According to the storage control device 101, it is possible to write the writing target data based on the calculated stripe depth and the calculated size of the padding data.

Consequently, it is possible to manage data (writing target data) which is requested to be written in the stripe unit and thus to improve sequential I/O writing performance by reducing a write penalty. In other words, an amount of data to be written to a single disk is changed depending on a size of the writing target data, and thus it is possible to reduce a write penalty through adjustment so that each I/O matches a stripe boundary.

In addition, management information (for example, metadata entry which will be described later) for controlling access to the data which is distributed and written to the respective storage devices S1 to S4 may be stored in the storage devices S1 to S4, and may be stored in a memory of the storage control device 101.

[Hardware Configuration Example of Storage System 200]

Next, a description will be made of a hardware configuration example of a storage system 200 by exemplifying a case where the storage control device 101 is applied to the storage system 200 with RAID 5(5+1).

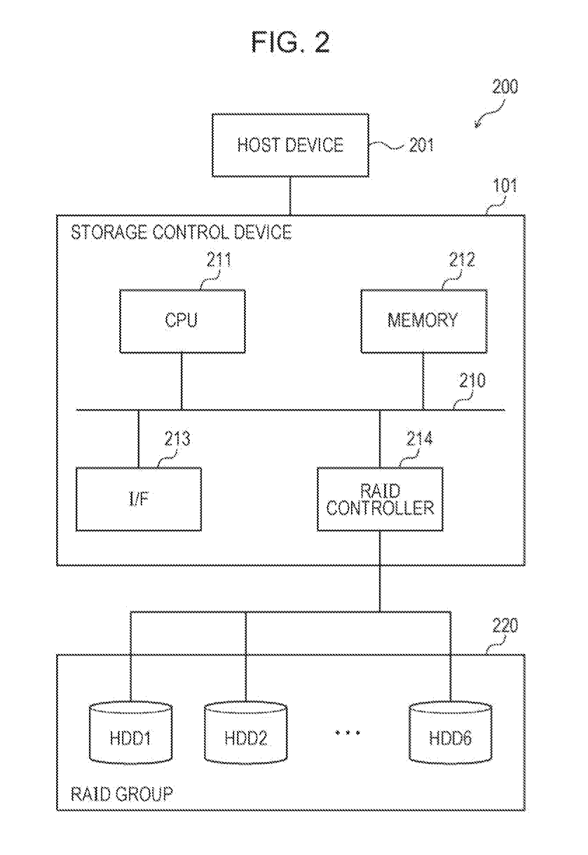

FIG. 2 is a block diagram illustrating a hardware configuration of the storage system 200. In FIG. 2, the storage system 200 includes the storage control device 101, an HDD 1 to an HDD 6, and a host device 201.

Here, the storage control device 101 includes a central processing unit (CPU) 211, a memory 212, an interface (I/F) 213, and a RAID controller 214. The constituent elements are connected to each other via a bus 210.

The CPU 211 controls the entire storage control device 101. The memory 212 includes, for example, a read only memory (ROM), a random access memory (RAM), and a flash ROM. More specifically, for example, the flash ROM stores a program such as an operating system (OS) or firmware, the ROM stores an application program, and the RAM is used as a work area of the CPU 211. The programs stored in the memory 212 are loaded to the CPU 211 so as to cause a process which is being coded to be executed by the CPU 211.

The I/F 213 controls inputting and outputting of data into and from other devices (for example, the host device 201). Specifically, for example, the I/F 213 is connected to networks such as Fibre Channel (FC), a local area network (LAN), a wide area network (WAN), or the Internet via a communication line, and is connected to other devices via the network. The I/F 213 manages the network and an internal interface and controls inputting and outputting of data to and from other devices.

The RAID controller 214 accesses the HDD 1 to the HDD 6 under the control of the CPU 211. The HDD 1 to the HDD 6 are storage devices in which a magnetic head performs reading or writing data through fast rotation of a disk (hard disk) coated with a magnetic body.

In the example illustrated in FIG. 2, the HDD 1 to the HDD 6 are grouped into one RAID group 220. The HDD 1 to the HDD 6 correspond to, for example, the storage devices S1 to S4 illustrated in FIG. 1. Instead of the HDDs, SSDs may be used. In the following description, the HDD or the SSD is simply referred to as a “disk” as a data storage in some cases.

The host device 201 is a computer which requests data to be read or written into a logical volume created on the RAID group 220. Specifically, for example, the host device 201 is a business server or a personal computer (PC) of a user using the storage system 200.

In the example illustrated in FIG. 2, as an example, a description has been made of a case where the number of HDDs in the storage system 200 is six such as the HDD 1 to the HDD 6, but the number thereof is not limited thereto. For example, the number of HDDs included in the storage system 200 may be any number as long as three or more HDDs including a single parity drive are provided. In the example illustrated in FIG. 2, each of the storage control device 101 and the host device 201 is illustrated alone, but a plurality of storage control devices 101 or host devices 201 may be included in the storage system 200.

[Layout Example on Physical Disk of RAID Group 220]

Next, a description will be made of a layout example on a physical disk of the RAID group 220 formed of the HDD 1 to the HDD 6 illustrated in FIG. 2.

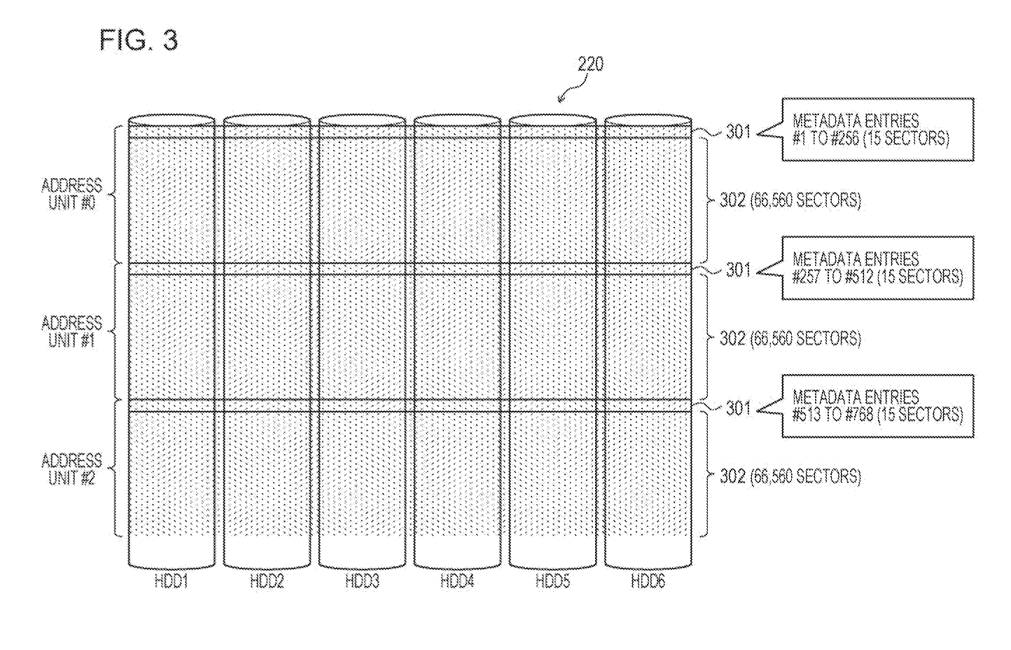

FIG. 3 is a diagram illustrating a layout example on a physical disk of the RAID group 220. In FIG. 3, the RAID group 220 is obtained by collecting the HDD 1 to the HDD 6 into one group, partitioned by a preset size, and divided into a plurality of address units (address units #0 to #2 in the example illustrated in FIG. 3).

Each of the address units #0 to #2 is divided into a metadata entry region 301 and a user data region 302 from the head. A plurality of metadata entries is disposed in the metadata entry region 301. The metadata entry is metadata for management. In the head of each of the address units #0 to #2, a logical address and a physical address are uniquely mapped to each other as a layout. In other words, in each address unit, correspondence between a logical address and a physical address is set on each occasion depending on a requested I/O pattern, but a physical address managed in each address unit is fixed, and thus a relationship between a logical address and a physical address in the head of each address unit is fixed.

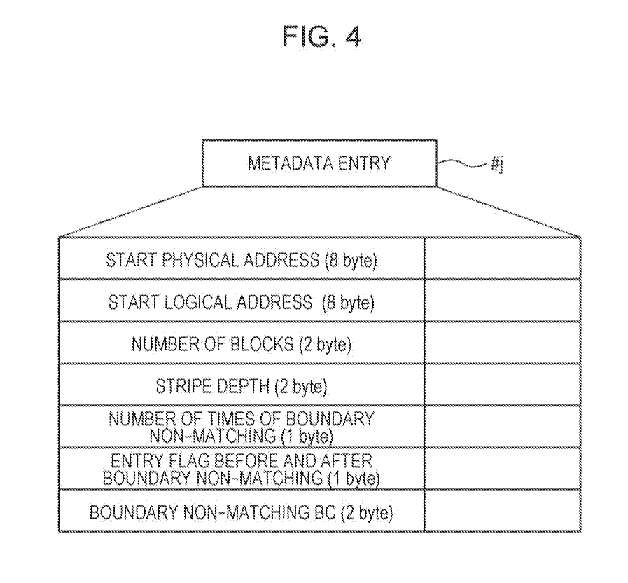

A data structure of the metadata entry will be described later with reference to FIG. 4.

The user data region 302 is appropriately allocated to each logical volume created on the RAID group 220 so as to be used, and stores data (user data) of each logical volume. Here, a volume to which a request for sequential I/O is made is used as the logical volume created on the RAID group 220.

It is assumed that the number of metadata entries in each of address units #0 to #2 is “256”, and a size of each metadata entry is “24 bytes”.

In addition, it is assumed that the minimum size of an expected I/O size is “128 KB”. The minimum size of the expected I/O size is appropriately set, for example, according to an OS or an application of the host device 201 (for example, several tens of KB to several MB).

In this case, a margin of a physical region managed by each metadata entry is “4 sectors (=2 KB=512 bytes×(5-1)=2,048 bytes). Here, 1 sector is 512 bytes. A reference size of the physical region managed by each metadata entry is “260 sectors (=130 KB=128 KB+2 KB)”.

A size of the user data region 302 of each of the address units #0 to #2 is “66,560 sectors (=33,280 KB=130 KB×256+α)”. Here, α is an adjustment region for adjusting a user data size to a stripe size. In addition, α is “α=0 KB”.

From the above description, a size of each of the address units #0 to #2 is “66,570 sectors (=33287.5 KB=24 bytes×256+β+33280 KB)”. Here, β is a size of padding data between the metadata entry region 301 and the user data region 302. In addition, β is “β=1.5 KB”. A size of the metadata entry region 301 of each of the address units #0 to #2 is “15 sectors (=24 bytes×256+1.5 KB)”.

Here, since a size of each write chunk is dynamically changed depending on a size of data requested to be written from the host device 201, a capacity margin for matching the size of data written to the disk with a stripe boundary is desired. The write chunk is a single stripe written to the disk at one writing request.

A target of the present embodiment is sequential I/O. For this reason, when the RAID group 220 is defined, as described above, a layout on the disk can be determined by setting the minimum size of an expected I/O size and obtaining the maximum number of write chunks and a desired capacity margin in the address unit.

In the following description, 256 metadata entries in the metadata entry region 301 of the address unit #0 are referred to as “metadata entries #1 to #256” in some cases. In addition, 256 metadata entries in the metadata entry region 301 of the address unit #1 are referred to as “metadata entries #257 to #512” in some cases. Further, 256 metadata entries in the metadata entry region 301 of the address unit #2 are referred to as “metadata entries #513 to #768” in some cases.

Among the metadata entries #1 to #768 of the metadata entry regions 301 of the address units #0 to #2, any metadata entry is referred to as a “metadata entry #j” (where j=1, 2, . . . , and 768) in some cases. [Data Structure Example of Metadata Entry #j]

Next, a description will be made of a data structure example of the metadata entry #j.

FIG. 4 is a diagram illustrating a data structure example of the metadata entry #j. In FIG. 4, the metadata entry #j includes a start physical address, a start logical address, the number of blocks, a stripe depth, the number of times of boundary non-matching, an entry flag before and after boundary non-matching, and boundary non-matching BC. In FIG. 4, the numerical value in the parenthesis subsequent to each member name of the metadata entry #j indicates a size of each member.

Here, the start physical address (8 bytes) is a physical address of the head of a write chunk. The start logical address (8 bytes) is a logical address of the head of data stored in the write chunk. The number of blocks (2 bytes) is the number of blocks stored in the write chunk. The stripe depth (2 bytes) is a stripe depth of the write chunk.

The number of times of boundary non-matching (1 byte) is the number of times in which boundary non-matching occurs during overwriting of data to the write chunk. The entry flag before and after boundary non-matching (1 byte) is a flag indicating whether or not a writing request of boundary non-matching straddles write chunks before and after boundary non-matching. The boundary non-matching BC (2 bytes) is an address offset in a case where a writing request is divided in the write chunk.

In an initial state, initial values (for example, all F) are set as values of the respective members. [Functional Configuration Example of Storage Control Device 101]

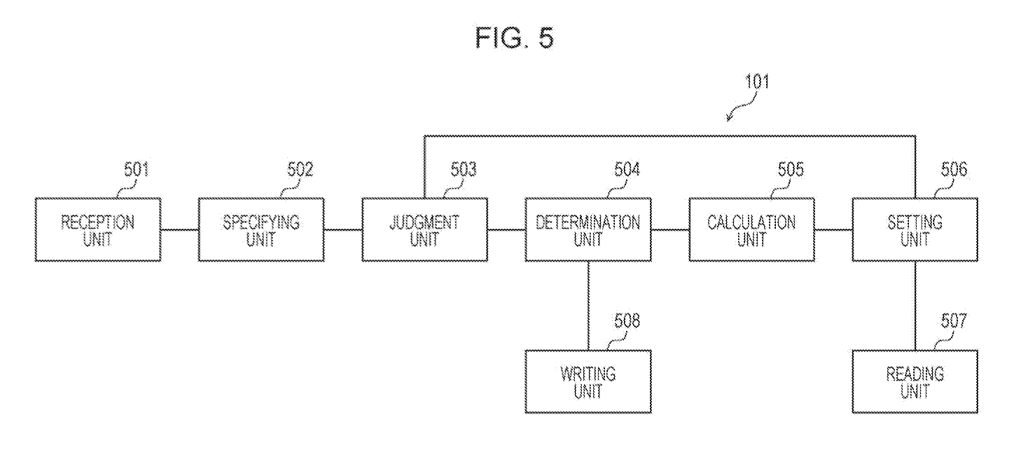

FIG. 5 is a block diagram illustrating a functional configuration example of the storage control device 101. In FIG. 5, the storage control device 101 is configured to include a reception unit 501, a specifying unit 502, a judgment unit 503, a determination unit 504, a calculation unit 505, a setting unit 506, a writing unit 507, and a reading unit 508. The reception unit 501 to the reading unit 508 function as a control unit, and, specifically, for example, functions thereof are realized by the CPU 211 executing the programs stored in the memory 212 illustrated in FIG. 2, or by the I/F 213 and the RAID controller 214. A processing result in each function unit is stored in, for example, the memory 212.

The reception unit 501 receives a writing request from the host device 201. Here, the writing request is a request for writing data into a logical volume created on the RAID group 220. The writing request includes, for example, information for specifying writing request data (writing target data) and a writing request range. The information for specifying the writing request range is, for example, a start logical address of the writing request range or the number of blocks of the writing request data.

The specifying unit 502 specifies an address unit #i (where i=0, 1, and 2) which is to be used this time from the address units #0 to #2 of the RAID group 220 based on the writing request range of the received writing request. Here, a logical address and a physical address are uniquely mapped to each other as a layout in the head of each of the address units #0 to #2.

For this reason, the specifying unit 502 divides, for example, a logical address in the writing request range by a total number of blocks b_{Total} of user data which can be disposed in an address unit, so as to specify the address unit #i which is used this time (here, 1 block=1 sector=512 bytes). The total number of blocks b_{Total} may be obtained, for example, by multiplying the minimum size of the expected I/O size by the number of metadata entries in the address unit.

More specifically, the specifying unit 502 specifies, for example, a quotient value obtained by dividing a head logical address in the writing request range by the total number of blocks b_{Total} as a unit number “i” of the address unit #i used this time. However, in a case where the writing request range exceeds the address unit, the writing request range is divided for each address unit.

The judgment unit 503 refers to a metadata entry group in the address unit #i so as to judge whether or not there is a metadata entry in use including the writing request range. Here, the metadata entry in use including the writing request range is a metadata entry in which at least a part of a managed range (writing request range) is included in the present writing request range.

More specifically, the metadata entry in use including the writing request range is a metadata entry in which any one of addresses in the present writing request range is set as a start logical address. In other words, the metadata entry in use including the writing request range being present indicates that there is data which has already been written in at least a part of the writing request range.

Specifically, for example, the judgment unit 503 reads a metadata entry group in the address unit #i used this time from the respective HDD 1 to the HDD 6. The judgment unit 503 judges whether or not there is a metadata entry in use including the writing request range by referring to the read metadata entry group.

In a case where a metadata entry group to be read is cached on the memory 212, the judgment unit 503 uses the metadata entry group on the memory 212.

In a case where there is no metadata entry in use including the writing request range, the determination unit 504 determines a metadata entry #j used this time from the metadata entry group in the address unit #i used this time. Specifically, for example, first, the determination unit 504 calculates the remainder obtained by dividing the head logical address in the writing request range by the total number of blocks b_{Total} as an offset value in the address unit #i used this time.

Next, the determination unit 504 calculates an entry number of a metadata entry candidate used this time in the address unit #i by dividing the calculated offset value by the minimum size of the expected I/O size. In a case where the metadata entry candidate with the calculated entry number is unused, the determination unit 504 determines the metadata entry candidate as a metadata entry #j used this time.

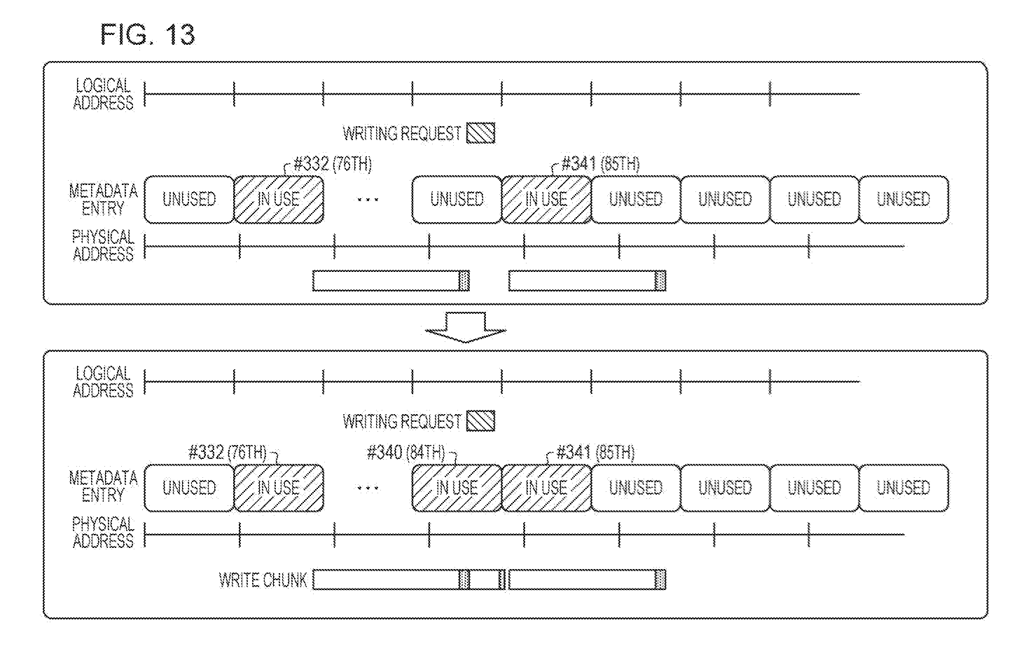

On the other hand, in a case where the metadata entry candidate is in use, the determination unit 504 determines an unused metadata entry on a head side or an end side of the metadata entry candidate as a metadata entry #j used this time. An example of determining whether or not a metadata entry candidate is in use will be described later with reference to FIG. 13.

The calculation unit 505 calculates a boundary adjustment value and a stripe depth based on a writing request size and the number of data disks. The writing request size is a size of data (writing target data) which is requested to be written. The boundary adjustment value is a size of padding data added to the writing request data in order to match a writing size with a stripe boundary (stripe size). The stripe depth is a size of data which is distributed and written to each data disk through striping, and is a size of a region (strip) storing data per disk in a single stripe.

Specifically, for example, the calculation unit 505 calculates the boundary adjustment value and the stripe depth so that “the writing request size+the boundary adjustment value” matches “the number of data disks×the stripe depth”. More specifically, for example, the calculation unit 505 calculates the remainder by dividing the writing request size by the number of data disks. Next, the calculation unit 505 calculates the boundary adjustment value by subtracting the calculated remainder from the number of data disks. The calculation unit 505 divides a value obtained by adding the boundary adjustment value to the writing request size, by the number of data disks, so as to calculate the stripe depth.

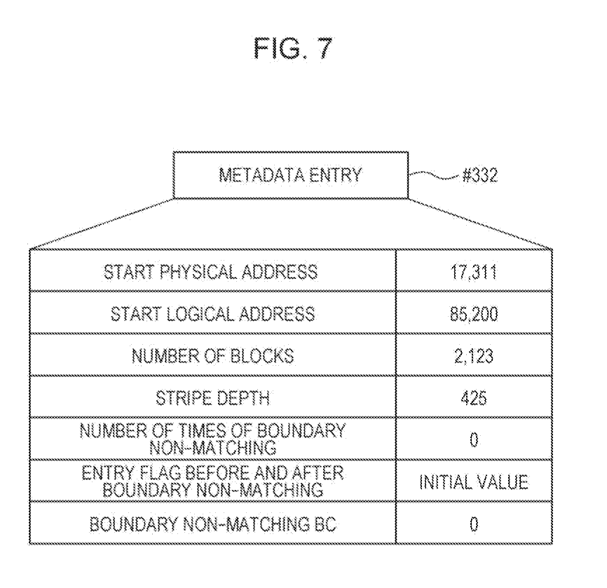

The setting unit 506 sets a start physical address, a start logical address, and the number of blocks in the metadata entry #j used this time along with the calculated stripe depth. An example of setting the metadata entry #j used this time will be described later with reference to FIG. 7 or the like.

The writing unit 507 writes the writing request data based on the calculated boundary adjustment value and stripe depth. Specifically, for example, the writing unit 507 attaches padding data (dummy data) corresponding to the boundary adjustment value to the end of the writing request data and divides the data in the unit of the stripe depth. The writing unit 507 generates parity data from the separate data group, and distributes and writes the separate data group and the parity data to the respective HDD 1 to HDD 6.

In a case where there is a metadata entry in use including the writing request range, the setting unit 506 updates the metadata entry in use. However, in a case where a range managed by the metadata entry in use matches the present writing request range, the setting unit 506 may not update the metadata entry in use.

Specifically, for example, the setting unit 506 sets boundary non-matching information indicating the number of times in which a writing request with the present writing request range is received. Here, the boundary non-matching information is, for example, the number of times of boundary non-matching, the entry flag before and after boundary non-matching, and the boundary non-matching BC illustrated in FIG. 4.

More specifically, for example, the setting unit 506 divides the present writing request range according to a range managed by the metadata entry in use. The setting unit 506 sets the number of times of boundary non-matching, the entry flag before and after boundary non-matching, and the boundary non-matching BC in the metadata entry in use in response to the division of the present writing request range.

The number of times of boundary non-matching is, for example, information indicating the number of times in which boundary non-matching occurs during overwriting of data to a write chunk as described above. In other words, according to the number of times of boundary non-matching, to specify the number of times in which a writing request to a writing request range whose boundary does not match a range managed by the metadata entry in use is generated.

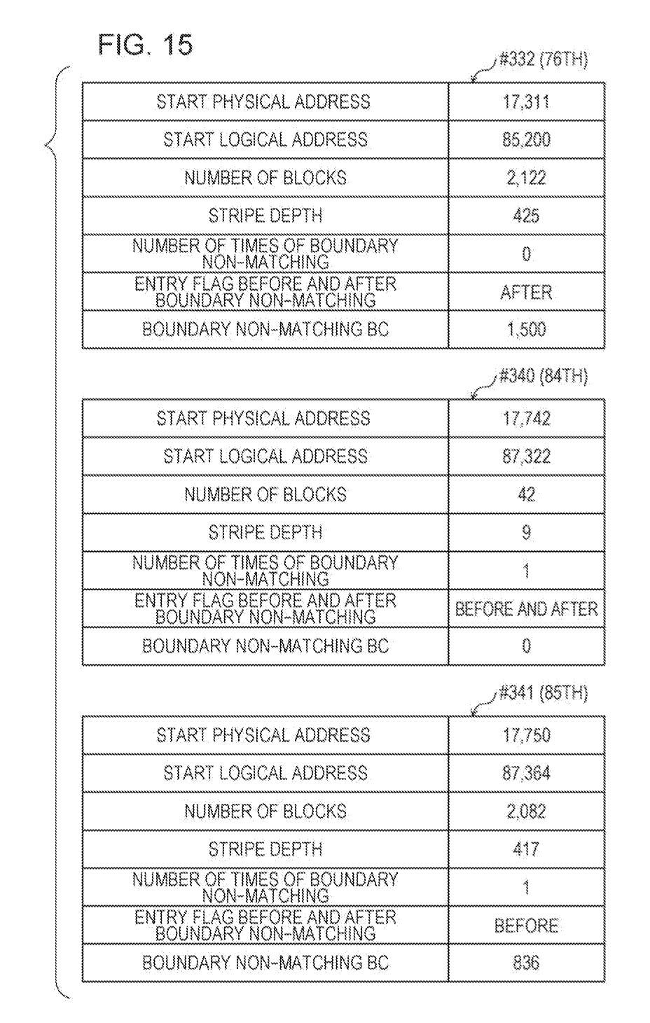

The entry flag before and after boundary non-matching and the boundary non-matching BC are information specifying a writing request range (hereinafter, referred to as an “overwriting range X” in some cases) of a writing request in which the number of times is managed by using the number of times of boundary non-matching. An example of updating a metadata entry in use will be described later with reference to FIG. 15.

The judgment unit 503 judges whether or not the number indicated by the boundary non-matching information of the metadata entry in use is equal to or more than a predefined value. The predefined value may be arbitrarily set. Specifically, for example, the judgment unit 503 judges whether or not the number of times of boundary non-matching of the metadata entry in use is equal to or more than the predefined value.

Here, in a case where the number of times of boundary non-matching is equal to or more than the predefined value, the calculation unit 505 recalculates a boundary adjustment value and a stripe depth by using data written in the overwriting range X which is specified based on the entry flag before and after boundary non-matching and the boundary non-matching BC, as writing request data. The setting unit 506 initializes the metadata entry in use in which the number of times of boundary non-matching is equal to or more than the predefined value.

The determination unit 504 determines a metadata entry #j which is newly used as described above. The setting unit 506 sets a start physical address, a start logical address, and the number of blocks in the metadata entry #j which is newly used along with the calculated stripe depth.

The calculation unit 505 also recalculates a boundary adjustment value and a stripe depth by using, as writing request data, data written in ranges other than the overwriting range X among ranges managed by the metadata entry in use in which the number of times of boundary non-matching is equal to or more than the predefined value. The determination unit 504 determines a metadata entry #j which is newly used, and the setting unit 506 sets various information in the metadata entry #j which is newly used.

Consequently, in a case where a writing request which does not match a stripe boundary is frequently generated, a stripe depth can be adjusted again. An example of adjusting a stripe depth again will be described later with reference to FIGS. 15 to 17.

The reception unit 501 receives a reading request from the host device 201. Here, the reading request is a request for reading data from a logical volume created on the RAID group 220. The reading request includes, for example, information for specifying a reading request range. The information for specifying the reading request range is, for example, a start logical address of the reading request range or the number of blocks of reading request data.

The specifying unit 502 specifies an address unit #i used this time from the address units #0 to #2 of the RAID group 220 based on the reading request range of the received reading request. The content of a process of specifying the address unit #i used this time is the same as a case of a writing request, and thus a description thereof will be omitted.

The determination unit 504 determines a metadata entry #j used this time from the metadata entry group in the address unit #i used this time. Specifically, for example, the determination unit 504 searches for a metadata entry in use including the reading request range from the metadata entry group in the address unit #i used this time.

Here, the metadata entry in use including the reading request range is a metadata entry in which at least a part of a managed range is included in the present reading request range. In other words, a write chunk including only the present reading request range is found from the start logical address and the number of blocks of each metadata entry. The determination unit 504 determines the metadata entry in use which is searched for as the metadata entry #j used this time.

The reading unit 508 reads the reading request data (data to be read) based on the determined metadata entry #j used this time. Specifically, for example, the reading unit 508 determines a target read from each disk based on the start logical address and the stripe depth of the metadata entry #j used this time. The reading unit 508 reads the determined reading target from each disk. The reading unit 508 outputs 0 data in response to a reading request to a region which does not store data.

In a case where a writing request regarding a size smaller than the minimum size of the expected I/O size is frequently generated, a management metadata entry may be insufficient. In this case, for example, the storage control device 101 writes writing request data without calculating a boundary adjustment value or a stripe depth. [First Processing Example for Writing Request]

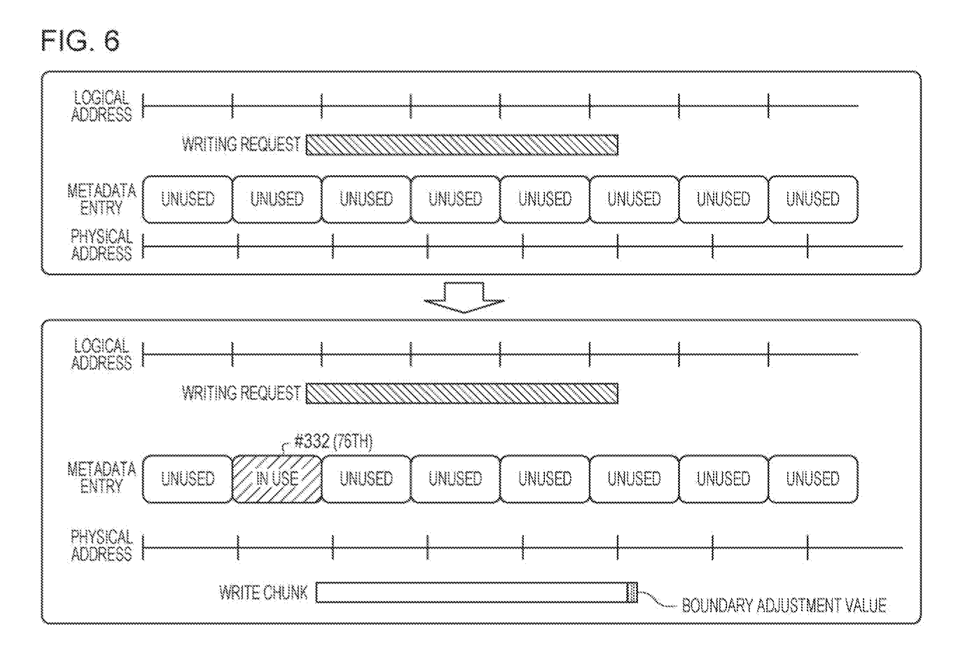

Next, with reference to FIGS. 6 to 8, a description will be made of a first processing example for a writing request received from the host device 201.

FIG. 6 is a diagram illustrating a first processing example for a writing request. Here, a case is assumed in which a writing request to 2,123 sectors in a range of logical sectors “85,200 to 87,322” is received.

First, the specifying unit 502 specifies an address unit #i used this time. Specifically, for example the specifying unit 502 specifies a quotient value obtained by dividing the logical sector “85,200” by the total number of blocks b_{Total}, as a unit number “i” of the address unit #i used this time.

The total number of blocks b_{Total} is “256 sectors×256 entries”. Thus, the specifying unit 502 specifies a quotient value “1” obtained by dividing the logical sector “85,200” by the total number of blocks b_{Total} “256 sectors×256 entries” as a unit number “i=1” of the address unit #i used this time. Consequently, it is possible to specify the address unit #1 used this time.

Next, the judgment unit 503 refers to the metadata entries #257 to #512 in the address unit #1 so as to judge whether or not there is a metadata entry in use including the writing request range.

Specifically, for example, first, in a case where a cache failure has occurred in the metadata entries #257 to #512, the judgment unit 503 reads the metadata entries #257 to #512 from each of the HDD 1 to the HDD 6. Here, a reading start position in each of the HDD 1 to the HDD 6 is the sector 13,314 (=the size of the address unit×the unit number÷the number of data disks=66,570×1÷5). A reading size is 3 sectors (=7.5 KB={24 bytes×256+α}÷5).

For this reason, the judgment unit 503 reads data by 3 sectors from the sector 13,314 in each of the HDD 1 to the HDD 6 so as to obtain the metadata entries #257 to #512. Here, it is assumed that there is no metadata entry in use including the writing request range “85,200 to 87,322” in the metadata entries #257 to #512.

Next, the determination unit 504 determines a metadata entry #j used this time from the metadata entries #257 to #512 in the address unit #1 used this time.

Specifically, for example, first, the determination unit 504 calculates the remainder by dividing the logical sector “85,200” by the total number of blocks b_{Total} “256 sectors×256 entries” as an offset value in the address unit #1. Here, the offset value in the address unit #1 is “19,664 (=85,200÷(256 sectors×256 entries))”.

Next, the determination unit 504 divides the offset value “19,664” by the minimum size “256 sectors” of the expected I/O size so as to calculate an entry number “76” of a metadata entry candidate used this time in the address unit #1. Consequently, it is possible to specify a metadata entry candidate #332 (a 76th metadata entry) used this time.

Hereinafter, a case is assumed in which the metadata entry candidate #332 is unused. In this case, the determination unit 504 determines the metadata entry candidate #332 as a metadata entry #332 used this time.

Next, the calculation unit 505 calculates the boundary adjustment value and the stripe depth so that “the writing request size+the boundary adjustment value” matches “the number of data disks×the stripe depth”.

Specifically, for example, the calculation unit 505 calculates the remainder “3” by dividing the writing request size “2,123 sectors” by the number of data disks “5”. Next, the calculation unit 505 calculates the boundary adjustment value “2 sectors” by subtracting the calculated remainder “3” from the number of data disks “5”. The calculation unit 505 divides a value “2,125 sectors” obtained by adding the boundary adjustment value to the writing request size, by the number of data disks “5”, so as to calculate the stripe depth “425 sectors”.

Next, the setting unit 506 sets a start physical address, a start logical address, the number of blocks, and the stripe depth in the metadata entry #332. The start physical address (disk address) may be obtained by using, for example, the following Equation (1).

Start physical address=(size of address unit×unit number+size of metadata entry region+offset value in address unit÷number of metadata entries×reference size of physical region managed by each metadata entry)÷number of data disks (1)

For this reason, the start physical address is “17,311 sectors=((66,570×1+15+19,664÷256×260)÷ 5)”. The start logical address is “85,200 sectors”. The number of blocks is “2,123 sectors”. The stripe depth is “425 sectors”.

The setting unit 506 checks the previous and present metadata entries so as to confirm whether or not a region into which data is written this time is already in use. If the region is in use, the start physical address is adjusted.

FIG. 7 is a diagram (first) illustrating an example of setting a metadata entry #j. In FIG. 7, the start physical address “17,311 sectors”, the start logical address “85,200 sectors”, the number of blocks “2,123 sectors”, and the stripe depth “425 sectors” are set in the metadata entry #332. The number of times of boundary non-matching “0”, the entry flag before and after boundary non-matching “initial value”, and the boundary non-matching BC “0” are set in the metadata entry #332.

Here, a description will be made of a disk image of the HDD 1 to the HDD 6 in which the writing request is completed.

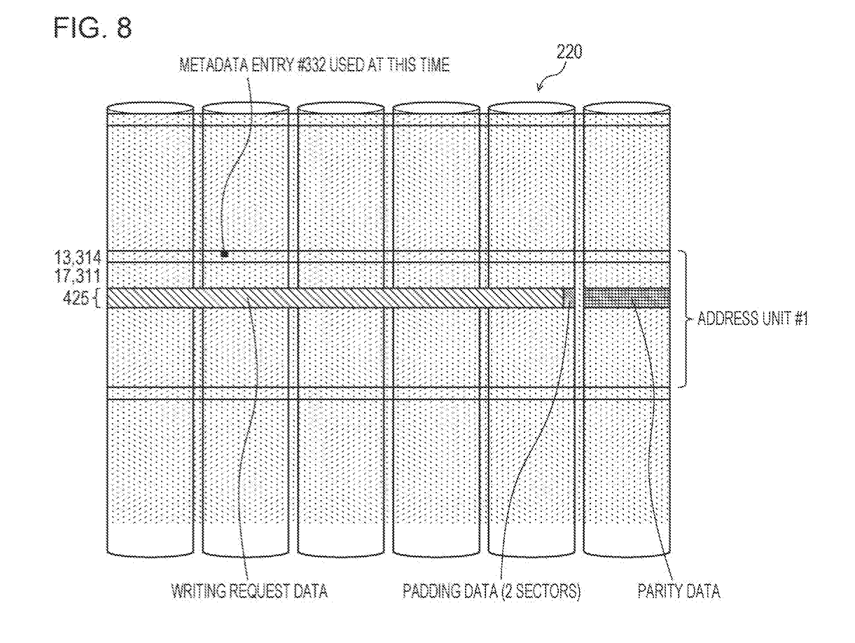

FIG. 8 is a diagram illustrating a disk image of the HDD 1 to the HDD 6. As illustrated in FIG. 8, if setting in the metadata entry #332 is completed, the writing unit 507 generates parity data and a writing process of writing request data. The parity data is preferably distributed to the respective disks in the RAID group 220. A logic regarding parity distribution is well known, and thus a description thereof will be omitted.

[Second Processing Example for Writing Request]

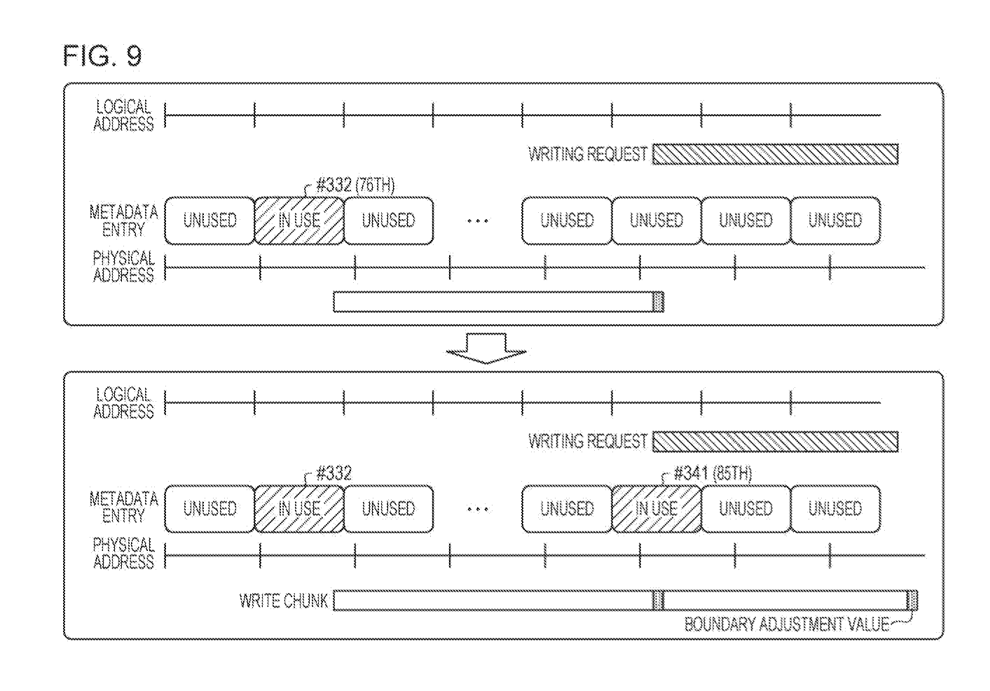

Next, with reference to FIGS. 9 to 11, a description will be made of a second processing example for a writing request received from the host device 201.

FIG. 9 is a diagram illustrating a second processing example for a writing request. Here, a case is assumed in which a writing request to 2,123 sectors in a range of logical sectors “87,323 to 89,445” is received in a state in which the writing request described with reference to FIGS. 6 to 8 is completed.

First, the specifying unit 502 specifies an address unit #i used this time. Specifically, for example the specifying unit 502 specifies a quotient value “1” obtained by dividing the logical sector “87,323” by the total number of blocks b_{Total}, as a unit number “i=1” of the address unit #i used this time.

Next, the judgment unit 503 refers to the metadata entries #257 to #512 in the address unit #1 so as to judge whether or not there is a metadata entry in use including the writing request range. Here, it is assumed that there is no metadata entry in use including the writing request range “87,323 to 89,445” in the metadata entries #257 to #512.

Next, the determination unit 504 determines a metadata entry #j used this time from the metadata entries #257 to #512 in the address unit #1 used this time.

Specifically, for example, first, the determination unit 504 calculates the remainder by dividing the logical sector “87,323” by the total number of blocks b_{Total} “256 sectors×256 entries” as an offset value in the address unit #1. Here, the offset value in the address unit #1 is “21,787”.

Next, the determination unit 504 divides the offset value “21,787” by the minimum size “256 sectors” of the expected I/O size so as to calculate an entry number “85” of a metadata entry candidate used this time in the address unit #1. Consequently, it is possible to specify a metadata entry candidate #341 (an 85th metadata entry) used this time.

Hereinafter, a case is assumed in which the metadata entry candidate #341 is unused. In this case, the determination unit 504 determines the metadata entry candidate #341 as a metadata entry #341 used this time.

Next, the calculation unit 505 calculates the boundary adjustment value and the stripe depth so that “the writing request size+the boundary adjustment value” matches “the number of data disks×the stripe depth”. Here, the boundary adjustment value is “2 sectors”, and the stripe depth is “425 sectors”.

Next, the setting unit 506 sets a start physical address, a start logical address, the number of blocks, and the stripe depth in the metadata entry #341. The start physical address is “17,742 sectors” from the above Equation (1). The start logical address is “87,323 sectors”. The number of blocks is “2,123 sectors”. The stripe depth is “425 sectors”.

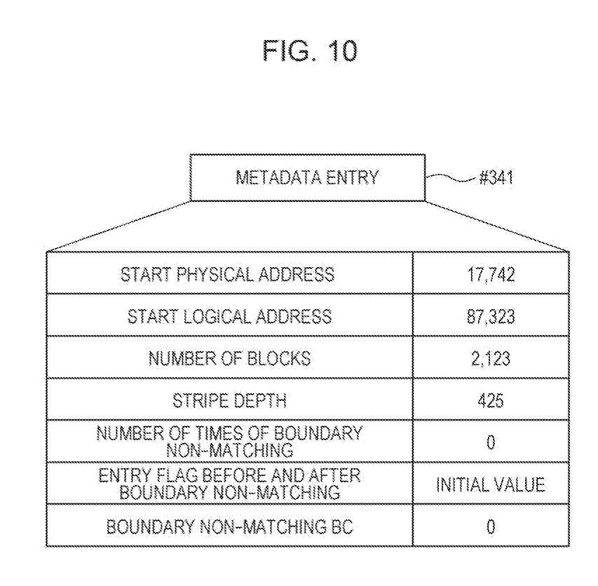

FIG. 10 is a diagram (second) illustrating an example of setting a metadata entry #j. In FIG. 10, the start physical address “17,742 sectors”, the start logical address “87,323 sectors”, the number of blocks “2,123 sectors”, and the stripe depth “425 sectors” are set in the metadata entry #341. The number of times of boundary non-matching “0”, the entry flag before and after boundary non-matching “initial value”, and the boundary non-matching BC “0” are set in the metadata entry #341.

Here, a description will be made of a disk image of the HDD 1 to the HDD 6 in which the writing request is completed.

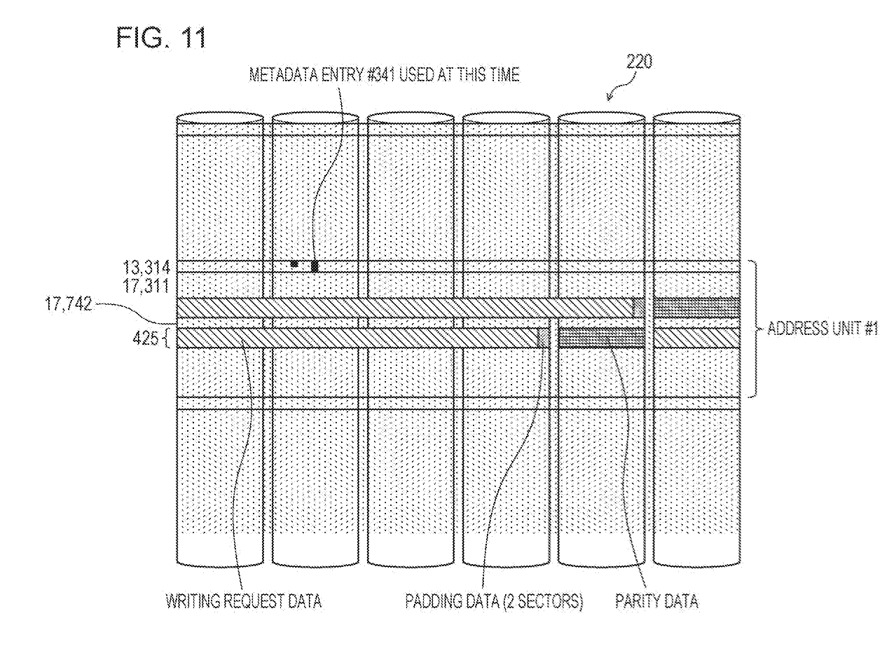

FIG. 11 is a diagram illustrating a disk image of the HDD 1 to the HDD 6. As illustrated in FIG. 11, if setting in the metadata entry #341 is completed, the writing unit 507 generates parity data and a writing process of writing request data.

[Third Processing Example for Writing Request]

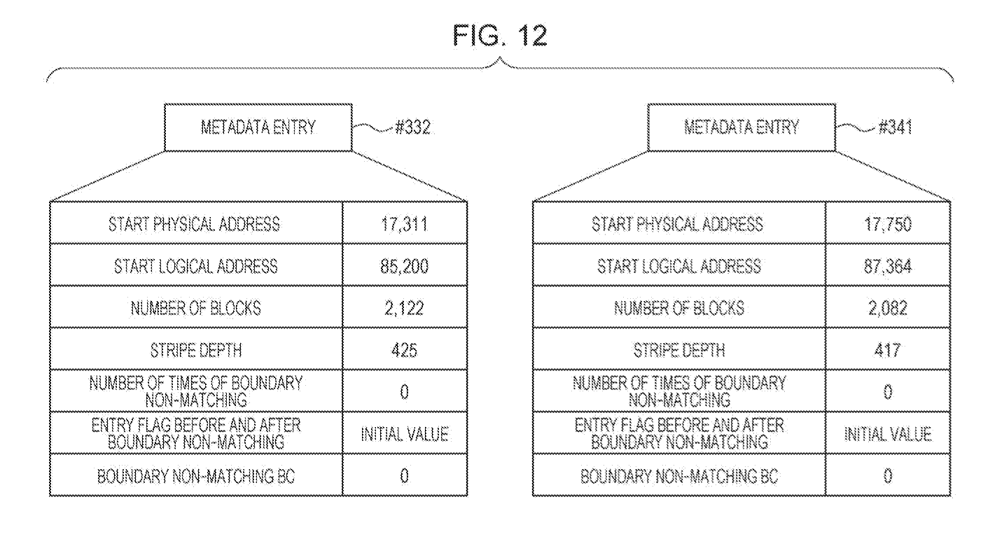

Next, with reference to FIGS. 12 to 14, a description will be made of a third processing example for a writing request received from the host device 201.

Here, a case is assumed in which a writing request to 2,122 sectors in a range of logical sectors “85,200 to 87,321” and 2,082 sectors in a range of logical sectors “87,364 to 89,445” has already been made.

In this case, metadata entries used in the writing request are the 76th metadata entry candidate #332 and the 85th metadata entry candidate #341. The set content of the metadata entry candidate #332 (76th) and the metadata entry candidate #341 (85th) are as illustrated in FIGS. 7 and 10.

FIG. 12 is a diagram (third) illustrating an example of setting a metadata entry #j. In FIG. 12, the start physical address “17,311 sectors”, the start logical address “85,200 sectors”, the number of blocks “2,122 sectors”, and the stripe depth “425 sectors” are set in the metadata entry #332.

The start physical address “17,750 sectors”, the start logical address “87,364 sectors”, the number of blocks “2,082 sectors”, and the stripe depth “417 sectors” are set in the metadata entry #341.

FIG. 13 is a diagram illustrating a third processing example for a writing request. Here, a case is assumed in which a writing request (short block) for 42 sectors in a range of logical sectors “87,322 to 87,363” is received in a state in which the writing request is completed.

First, the specifying unit 502 specifies an address unit #i used this time. Specifically, for example the specifying unit 502 specifies a quotient value “1” obtained by dividing the logical sector “87,322” by the total number of blocks b_{Total}, as a unit number “i=1” of the address unit #i used this time.

Next, the judgment unit 503 refers to the metadata entries #257 to #512 in the address unit #1 so as to judge whether or not there is a metadata entry in use including the writing request range. Here, it is assumed that there is no metadata entry in use including the writing request range “87,322 to 87,363” in the metadata entries #257 to #512.

Next, the determination unit 504 determines a metadata entry #j used this time from the metadata entries #257 to #512 in the address unit #1 used this time.

Specifically, for example, first, the determination unit 504 calculates the remainder by dividing the logical sector “87,322” by the total number of blocks b_{Total} “256 sectors×256 entries” as an offset value in the address unit #1. Here, the offset value in the address unit #1 is “21,786”.

Next, the determination unit 504 divides the offset value “21,786” by the minimum size “256 sectors” of the expected I/O size so as to calculate an entry number “85” of a metadata entry candidate used this time in the address unit #1. Here, the 85th metadata entry #341 is in use in order to manage the logical sectors “87,364 to 89,445”.

In this case, an unused metadata entry on the head side or the end side of the metadata entry #341 is determined as a metadata entry #j used this time. Here, the present writing request range is less than the logical sector “87,364”. For this reason, the determination unit 504 searches for an unused metadata entry on the head side of the metadata entry #341.

Here, an 84th metadata entry #340 is unused. In this case, the determination unit 504 determines the metadata entry #340 which is searched for as a metadata entry used this time. In a case where the 84-th metadata entry #340 is in use, the determination unit 504 slides each metadata entry in use to the head side as occasion calls so as to secure a metadata entry used this time.

For example, if an 83rd metadata entry #339 is unused, the determination unit 504 copies the content set in the 84th metadata entry #340 to the 83rd metadata entry #339. The determination unit 504 determines the 84th metadata entry #340 as a metadata entry used this time. However, start addresses managed by the respective metadata entries are controlled in ascending order.

Next, the calculation unit 505 calculates the boundary adjustment value and the stripe depth so that “the writing request size+the boundary adjustment value” matches “the number of data disks×the stripe depth”. Here, the boundary adjustment value is “3 sectors”, and the stripe depth is “9 sectors”.

Next, the setting unit 506 sets a start physical address, a start logical address, the number of blocks, and the stripe depth in the metadata entry #340. The start physical address is “17,742 sectors” from the above Equation (1). The start logical address is “87,322 sectors”. The number of blocks is “42 sectors”. The stripe depth is “9 sectors”.

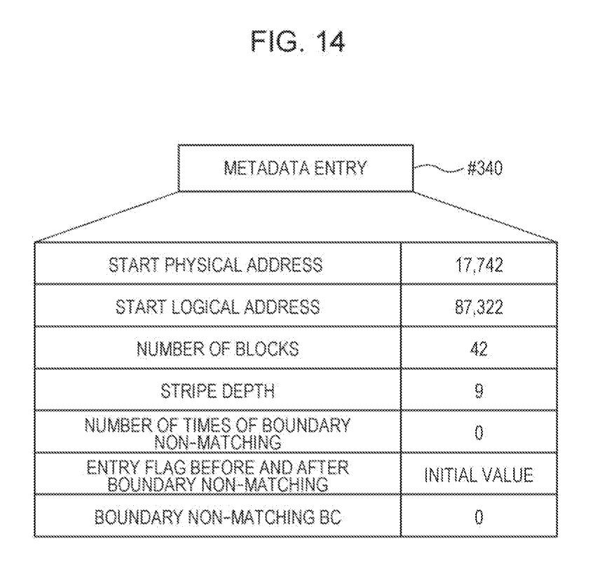

FIG. 14 is a diagram (fourth) illustrating an example of setting a metadata entry #j. In FIG. 14, the start physical address “17,742 sectors”, the start logical address “87,322 sectors”, the number of blocks “42 sectors”, and the stripe depth “9 sectors” are set in the metadata entry #340.

If setting in the metadata entry #340 is completed, the writing unit 507 generates parity data and a writing process of writing request data.

[Readjustment of Stripe Depth]

Next, a description will be made of readjustment of a stripe depth with reference to FIGS. 15 to 17.

Here, it is assumed that readjustment of a stripe depth occurs in a state in which the above-described third processing example is completed. The set content of the completed 76th metadata entry candidate #332, 84th metadata entry candidate #340, and 85th metadata entry candidate #341 is as illustrated in FIGS. 12 and 14.

Here, it is assumed that a writing request (overwriting) for 1,500 sectors in a range of logical sectors “86,700 to 88,199” is received.

First, the specifying unit 502 specifies an address unit #i used this time. Specifically, for example the specifying unit 502 specifies a quotient value “1” obtained by dividing the logical sector “86,700” by the total number of blocks b_{Total} as a unit number “i=1” of the address unit #i used this time.

Next, the judgment unit 503 refers to the metadata entries #257 to #512 in the address unit #1 so as to judge whether or not there is a metadata entry in use including the writing request range. Here, there are metadata entries #332, #340 and #341 in use including the writing request range “86,700 to 88,199” in the metadata entries #257 to #512.

In this case, the setting unit 506 updates the metadata entries #332, #340 and #341 in use. Specifically, for example, the setting unit 506 divides the writing request range “86,700 to 88,199” according to ranges managed by the metadata entries #332, #340 and #341 in use. Specifically, for example, the setting unit 506 divides the writing request range “86,700 to 88,199” into first, second and third division ranges.

Here, the first division range is a range corresponding to 622 sectors in the logical sectors “86,700 to 87,321”. The second division range is a range corresponding to 42 sectors in the logical sectors “87,322 to 87,363”. The third division range is a range corresponding to 836 sectors in the logical sectors “87,364 to 88,199”.

The setting unit 506 sets the number of times of boundary non-matching, the entry flag before and after boundary non-matching, and the boundary non-matching BC in the metadata entries #332, #340 and #341 in use in response to the division of the writing request range “86,700 to 88,199”.

FIG. 15 is a diagram (fifth) illustrating an example of setting a metadata entry #j. In FIG. 15, the setting unit 506 increments the number of times of boundary non-matching in the metadata entry #332. Since the present writing request (the writing request of boundary non-matching) straddles a write chunk after boundary non-matching, the setting unit 506 sets “after” in the entry flag before and after boundary non-matching. The setting unit 506 calculates an address offset “1,500 (=86,700−85,200)” indicating a divided location in the regions “85,200 to 87,321” managed by the metadata entry #332. The setting unit 506 sets “1,500” in the boundary non-matching BC.

Similarly, the setting unit 506 increments the number of times of boundary non-matching in the metadata entry #340. Since the present writing request (the writing request of boundary non-matching) straddles a write chunk before and after boundary non-matching, the setting unit 506 sets “before and after” in the entry flag before and after boundary non-matching. There is no divided location in the regions “87,322 to 87,363” managed by the metadata entry #340. In this case, the setting unit 506 sets “0” in the boundary non-matching BC.

Similarly, the setting unit 506 increments the number of times of boundary non-matching in the metadata entry #341. Since the present writing request (the writing request of boundary non-matching) straddles a write chunk before boundary non-matching, the setting unit 506 sets “before” in the entry flag before and after boundary non-matching. The setting unit 506 calculates an address offset “836 (=88,199+1−87,364)” indicating a divided location in the regions “87,364 to 89,445” managed by the metadata entry #341. The setting unit 506 sets “836” in the boundary non-matching BC.

Here, in the regions managed by the metadata entries #332 and #341, a write penalty is generated since parity data is generated after disk reading is performed, and then disk writing is performed. A write penalty is not generated in the regions managed by the metadata entry #340.

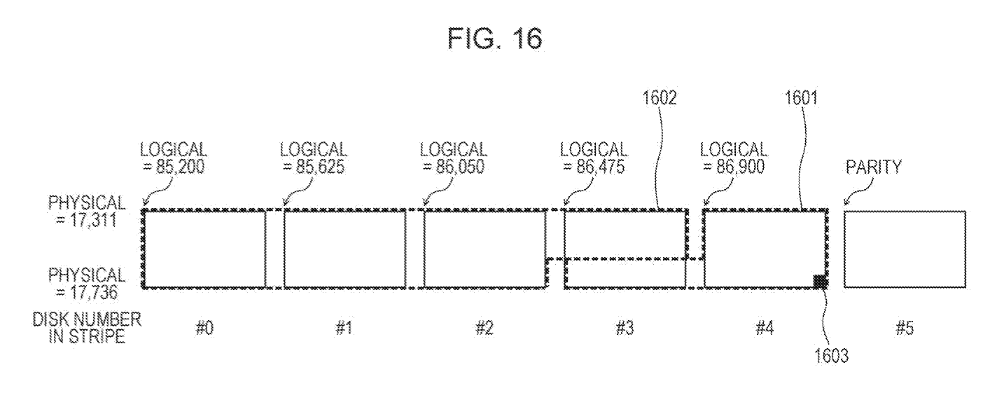

FIG. 16 illustrates correspondence between a physical address and a logical address by exemplifying the 76th metadata entry #332.

FIG. 16 is a diagram illustrating correspondence between a physical address and a logical address. In FIG. 16, a region 1601 is the present writing target range. A region 1602 is a region in which disk reading is desired in order to write data. A region 1603 is a stripe boundary adjustment region.

However, the region 1602 indicates a disk reading target range which is desired in a case where writing is performed in a method of generating new parity data by aligning all data items on a stripe.

Hereinafter, a description will be made of an operation example of readjustment of a stripe depth in a case where the number of times of boundary non-matching of each metadata entry is equal to or more than a predefined value.

The judgment unit 503 sequentially refers to metadata entries from the head so as to judge whether or not the number of times of boundary non-matching is equal to or more than the predefined value, and thus judges whether or not readjustment of a stripe depth is desired. Here, as an example, a description will be made of a case where the number of times of boundary non-matching of the 76th metadata entry #332 is equal to or more than the predefined value.

In this case, the judgment unit 503 refers to an entry flag before and after boundary non-matching of the metadata entry #332 so as to judge a metadata entry which is a connection target. Here, “after” is set in the entry flag before and after boundary non-matching of the metadata entry #332 (for example, refer to FIG. 15).

In this case, the judgment unit 503 searches for the next metadata entry in use of the metadata entry #332. Here, the 84th metadata entry #340 is searched for.

In this case, the judgment unit 503 refers to an entry flag before and after boundary non-matching of the metadata entry #340 so as to judge a metadata entry which is a connection target. Here, “before and after” is set in the entry flag before and after boundary non-matching of the metadata entry #340 (for example, refer to FIG. 15).

In this case, the judgment unit 503 searches for the next metadata entry in use of the metadata entry #340. Here, the 85th metadata entry #341 is searched for.

In this case, the judgment unit 503 refers to an entry flag before and after boundary non-matching of the metadata entry #341 so as to judge a metadata entry which is a connection target. Here, “before” is set in the entry flag before and after boundary non-matching of the metadata entry #341 (for example, refer to FIG. 15).

In this case, the judgment unit 503 judges that metadata entries up to the metadata entry #341 are connection targets. Consequently, it is possible to specify the metadata entries #332, #340 and #341 which are connection targets. User data of the logical sectors “85,200 to 89,445” managed by the 76th, 84th and 85th metadata entries #332, #340 and #341 is read from the disks and is developed on the memory 212.

The storage control device 101 performs a writing process by receiving the following new writing request based on the boundary non-matching BC of each of the metadata entries #332, #340 and #341 (resetting of a write chunk).
1,500 sectors in the logical sectors “85,200 to 86,699”
1,500 sectors in the logical sectors “86,700 to 88,199”
1,246 sectors in the logical sectors “88,200 to 89,445”

In this case, the storage control device 101 temporarily initializes the set content of each of the 76th, 84th and 85th metadata entries #332, #340 and #341, and, as described above, determines and sets a metadata entry for each writing request (resetting of a metadata entry).

Here, metadata entries used for respective new writing requests (reset write chunks) are 76th, 82nd and 88th metadata entries #332, #337 and #343. Hereinafter, the storage control device 101 performs generation of parity data and disk writing.

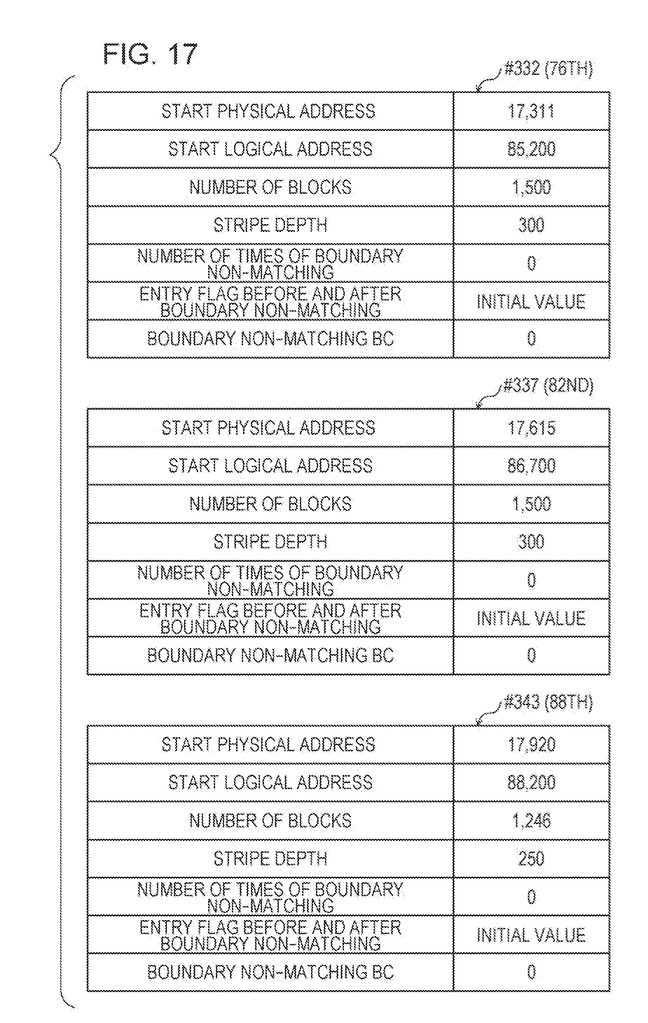

Here, a description will be made of the set content of the 76th, 82nd and 88th metadata entries #332, #337 and #343 after the stripe depth is readjusted with reference to FIG. 17.

FIG. 17 is a diagram (sixth) illustrating an example of setting a metadata entry #j. In FIG. 17, the start physical address “17,311 sectors”, the start logical address “85,200 sectors”, the number of blocks “1,500 sectors”, and the stripe depth “300 sectors” are set in the metadata entry #332. The number of times of boundary non-matching “0”, the entry flag before and after boundary non-matching “initial value”, and the boundary non-matching BC “0” are set in the metadata entry #332 as initial values.

The start physical address “17,615 sectors”, the start logical address “86,700 sectors”, the number of blocks “1,500 sectors”, and the stripe depth “300 sectors” are set in the metadata entry #337. The number of times of boundary non-matching “0”, the entry flag before and after boundary non-matching “initial value”, and the boundary non-matching BC “0” are set in the metadata entry #337 as initial values.

The start physical address “17,920 sectors”, the start logical address “88,200 sectors”, the number of blocks “1,246 sectors”, and the stripe depth “250 sectors” are set in the metadata entry #343. The number of times of boundary non-matching “0”, the entry flag before and after boundary non-matching “initial value”, and the boundary non-matching BC “0” are set in the metadata entry #343 as initial values.

[Various Process Procedures in Storage Control Device 101]

Next, a description will be made of a various process procedures in the storage control device 101. Here, first, a description will be made of a writing process procedure in the storage control device 101.

[Writing Process Procedure]

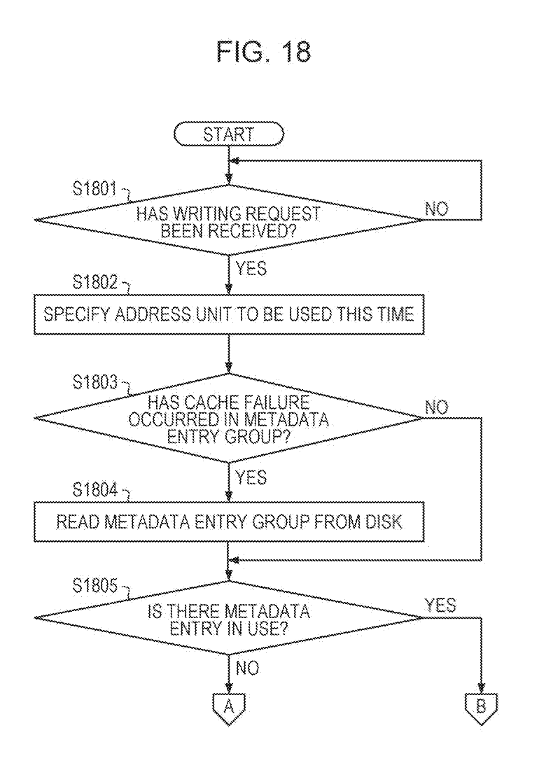

FIGS. 18 to 20 are flowcharts illustrating an example of the writing process procedure in the storage control device 101. In the flowchart illustrated in FIG. 18, first, the storage control device 101 judges whether or not a writing request has been received from the host device 201 (step S1801). Here, the storage control device 101 waits for a writing request to be received (No in step S1801).

In a case where a writing request has been received (Yes in step S1801), the storage control device 101 specifies an address unit #i used this time from the address units #0 to #2 of the RAID group 220 based on a writing request range of the writing request (step S1802).

Next, the storage control device 101 judges whether or not a cache failure has occurred in a metadata entry group in the address unit #i used this time (step S1803). Here, in a case where the cache hit has been made in a metadata entry group (No in step S1803), the storage control device 101 proceeds to step S1805.

On the other hand, in a case where a cache failure has occurred in the metadata entry group (Yes in step S1803), the storage control device 101 reads the metadata entry group in the address unit #i used this time from the disks (the HDD 1 to the HDD 6) (step S1804).

The storage control device 101 judges whether or not there is a metadata entry in use including the writing request range by referring to the metadata entry group in the address unit #i used this time (step S1805).

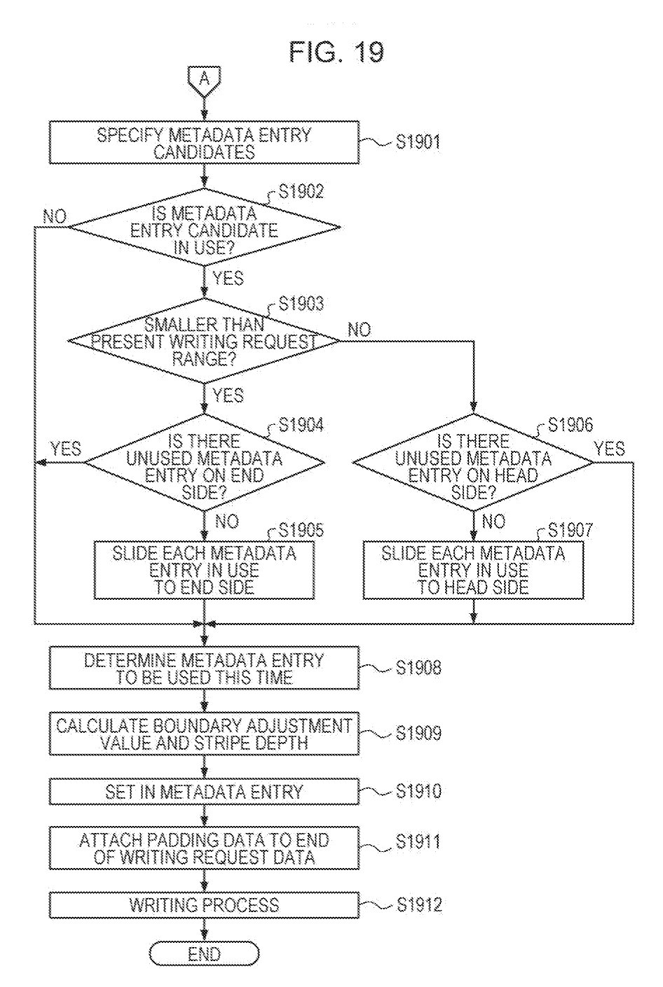

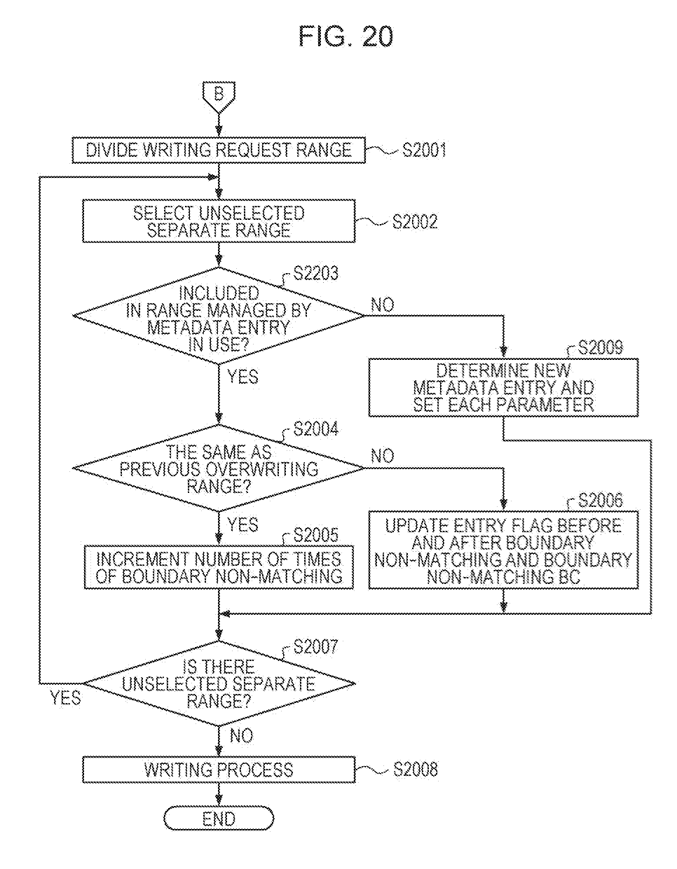

Here, in a case where there is no metadata entry in use (No in step S1805), the storage control device 101 proceeds to step S1901 illustrated in FIG. 19. On the other hand, in a case where there is a metadata entry in use (Yes in step S1805), the storage control device 101 proceeds to step S2001 illustrated in FIG. 20.

In the flowchart illustrated in FIG. 19, first, the storage control device 101 specifies a metadata entry candidate used this time from the metadata entry group in the address unit #i used this time (step S1901). The storage control device 101 judges whether or not the metadata entry candidate is in use (step S1902).

Here, in a case where the metadata entry candidate is unused (No in step S1902), the storage control device 101 proceeds to step S1908 and determines the metadata entry candidate as a metadata entry #j used this time (step S1908).

On the other hand, in a case where the metadata entry candidate is in use (Yes in step S1902), the storage control device 101 judges whether or not a range managed by the metadata entry candidate is smaller than the present writing request range (step S1903). In a case where the range is smaller than the present writing request range (Yes in step S1903), the storage control device 101 judges whether or not there is an unused metadata entry on the end side of the metadata entry candidate (step S1904).

Here, in a case where there is an unused metadata entry (Yes in step S1904), the storage control device 101 proceeds to step S1908 and determines the unused metadata entry on the end side as a metadata entry #j used this time (step S1908).

On the other hand, in a case where there is no unused metadata entry (No in step S1904), the storage control device 101 slides each metadata entry in use to the end side as occasion calls so as to secure a metadata entry used this time (step S1905). The storage control device 101 determines the secured metadata entry as a metadata entry #j used this time (step S1908).

In a case where the range is more than the present writing request range in step S1903 (No in step S1903), the storage control device 101 judges whether or not there is an unused metadata entry on the head side of the metadata entry candidate (step S1906).

Here, in a case where there is an unused metadata entry (Yes in step S1906), the storage control device 101 proceeds to step S1908, and determines the unused metadata entry on the head side as a metadata entry #j used this time (step S1908).

On the other hand, in a case where there is no unused metadata entry (No in step S1906), the storage control device 101 slides each metadata entry in use to the end side as occasion calls so as to secure a metadata entry used this time (step S1907). The storage control device 101 determines the secured metadata entry as a metadata entry #j used this time (step S1908).

Next, the storage control device 101 calculates a boundary adjustment value and a stripe depth based on a writing request size and the number of data disks (step S1909). The storage control device 101 sets a start physical address, a start logical address, and the number of blocks in the metadata entry #j used this time along with the calculated stripe depth (step S1910).

Next, the storage control device 101 attaches padding data (dummy data) corresponding to the boundary adjustment value to the end of the writing request data (step S1911). The storage control device 101 performs a writing process of the writing request data to which the padding data is attached (step S1912), and a series of processes in this flowchart is finished.

In the flowchart illustrated in FIG. 20, first, the storage control device 101 divides the writing request range at a boundary of ranges managed by the metadata entry in use including the writing request range (step S2001). The storage control device 101 selects an unselected separate range among separate ranges which are divided from the writing request range (step S2002).

Next, the storage control device 101 judges whether or not the selected separate range is included in a range managed by the metadata entry in use including the writing request range (step S2003).

Here, in a case where the selected separate range is included in the range managed by the metadata entry in use (Yes in step S2003), the storage control device 101 judges whether or not judges whether or not the present overwriting range is the same as the previous overwriting range (step S2004). The previous overwriting range is specified based on an entry flag before and after boundary non-matching and boundary non-matching BC of the metadata entry in use.

Here, in a case where the present overwriting range is the same as the previous overwriting range (Yes in step S2004), the storage control device 101 increments the number of times of boundary non-matching of the metadata entry in use (step S2005), and proceeds to step S2007. On the other hand, in a case where the present overwriting range is different from the previous overwriting range (No in step S2004), the storage control device 101 updates the entry flag before and after boundary non-matching and the boundary non-matching BC of the metadata entry in use based on the present overwriting range (step S2006).

The storage control device 101 judges whether or not there is an unselected separate range which is not selected among the separate ranges divided from the writing request range (step S2007). Here, in a case where there is an unselected separate range (Yes in step S2007), the storage control device 101 returns to step S2002.

On the other hand, in a case where there is no unselected separate range (No in step S2007), the storage control device 101 performs a writing process of the writing request data (step S2008), and finishes a series of processes in this flowchart.

In a case where the selected separate range is not included in the range managed by the metadata entry in use in step S2003 (No in step S2003), the storage control device 101 determines a new metadata entry for the selected separate range and sets respective parameters therein (step S2009), and proceeds to step S2007. The specific processing content in step S2009 is the same as, for example, the content in steps S1901 to S1910 illustrated in FIG. 19, and thus a description thereof will be omitted.

Consequently, it is possible to write writing request data so as not to generate a write penalty by changing an amount of data to be written to a single disk according to a size of the writing request data. A management metadata entry for controlling access to data which is distributed and written to the respective disks (the HDD 1 to the HDD 6) can be stored in the disks.

[Reading Process Procedure]

Next, a description will be made of a reading process procedure in the storage control device 101.

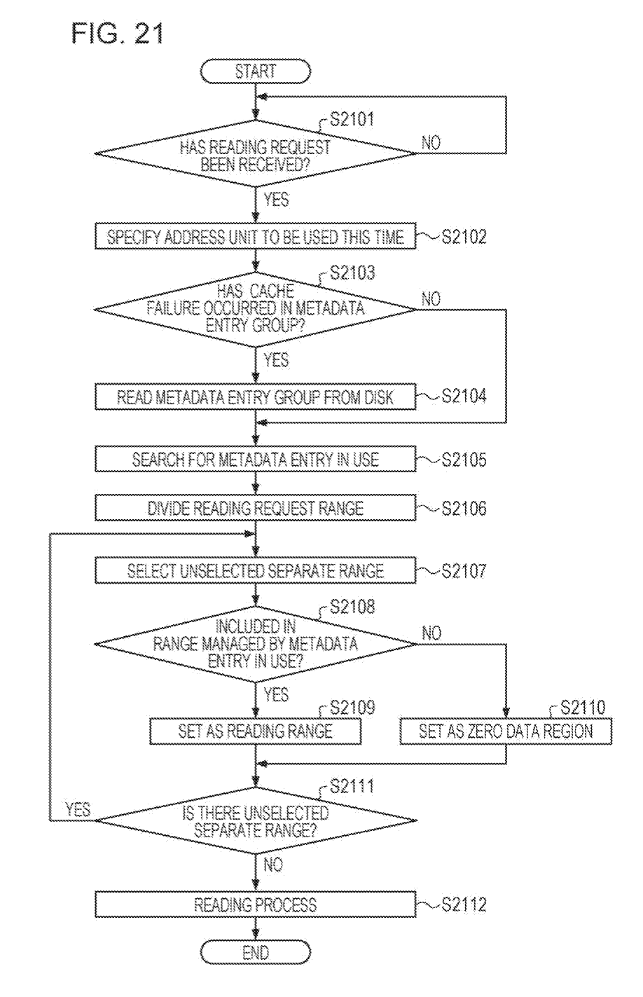

FIG. 21 is a flowchart illustrating an example of a reading process procedure in the storage control device 101. In the flowchart illustrated in FIG. 21, first, the storage control device 101 judges whether or not a reading request has been received from the host device 201 (step S2101). Here, the storage control device 101 waits for a reading request to be received (No in step S2101).

In a case where a reading request has been received (Yes in step S2101), the storage control device 101 specifies an address unit #i used this time from the address units #0 to #2 of the RAID group 220 based on a reading request range of the reading request (step S2102).

Next, the storage control device 101 judges whether or not a cache failure has occurred in a metadata entry group in the address unit #i used this time (step S2103). Here, in a case where the cache hit has been made in a metadata entry group (No in step S2103), the storage control device 101 proceeds to step 2105.

On the other hand, in a case where a cache failure has occurred in the metadata entry group (Yes in step S2103), the storage control device 101 reads the metadata entry group in the address unit #i used this time from the disks (the HDD 1 to the HDD 6) (step S2104).

The storage control device 101 searches for a metadata entry in use including the reading request range from the metadata entry group in the address unit #i used this time (step S2105). The storage control device 101 divides the reading request range at a boundary of ranges managed by the metadata entry in use including the reading request range (step S2106).

Next, the storage control device 101 selects an unselected separate range among separate ranges which are divided from the reading request range (step S2107). The storage control device 101 judges whether or not the selected separate range is included in a range managed by the metadata entry in use including the reading request range (step S2108).

Here, in a case where the selected separate range is included in the range managed by the metadata entry in use (Yes in step S2108), the storage control device 101 sets the selected separate range as a reading request (step S2109), and proceeds to step S2111. On the other hand, in a case where the selected separate range is not included in the range managed by the metadata entry in use (No in step S2108), the storage control device 101 sets the selected separate range as a zero data region (data non-storage region) (step S2110).

The storage control device 101 judges whether or not there is an unselected separate range which is not selected among the separate ranges divided from the reading request range (step S2111). Here, in a case where there is an unselected separate range (Yes in step S2111), the storage control device 101 returns to step S2107.

On the other hand, in a case where there is no unselected separate range (No in step S2111), the storage control device 101 performs a reading process of the reading request data (step S2112), and finishes a series of processes in this flowchart. Specifically, for example, the storage control device 101 reads the set reading range, and prepares for and outputs 0 data in response to a reading request to the zero data region.

Consequently, it is possible to appropriately access data which is written in a stripe size changing depending on a size of writing request data and to read reading request data.

[Stripe Depth Readjustment Process Procedure]

Next, a description will be made of a stripe depth readjustment process procedure in the storage control device 101.

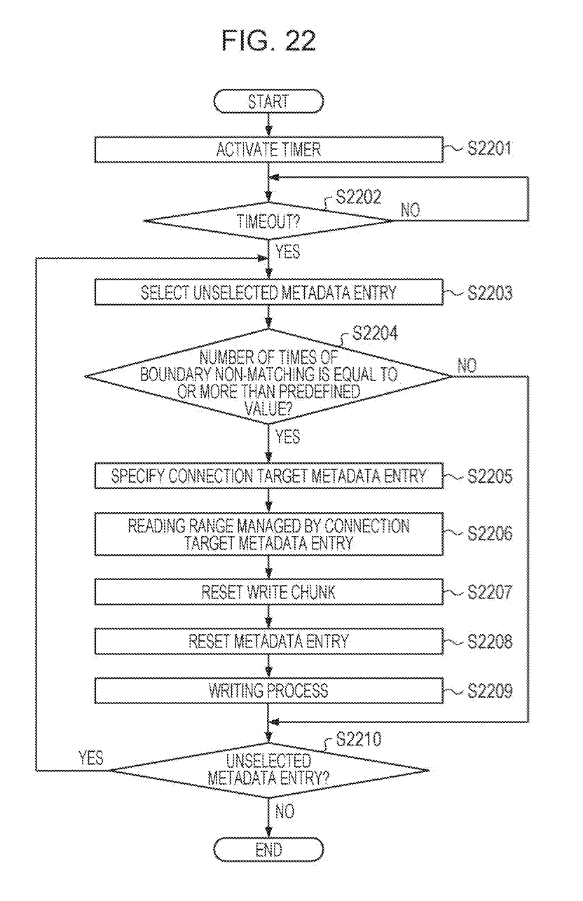

FIG. 22 is a flowchart illustrating an example of a stripe depth readjustment process procedure in the storage control device 101. In the flowchart illustrated in FIG. 22, first, the storage control device 101 activates a timer (step S2201).

Storage control device 101 judges whether or not the timer times out since a predefined time period has elapsed from the activation thereof (step S2202). The predefined time period may be arbitrarily set, and is set to, for example, several hours to several days. Here, the storage control device 101 waits for the timer to time out (No in step S2202).

In a case where the timer times out (Yes in step S2202), the storage control device 101 selects an unselected metadata entry #j from the heads of the metadata entry groups #1 to #768 in the address units #0 to #2 (step S2203). The storage control device 101 judges whether or not the number of times of boundary non-matching of the selected metadata entry #j is equal to or more than a predefined value (step S2204).

Here, in a case where the number of times of boundary non-matching is less than the predefined value (No in step S2204), the storage control device 101 proceeds to step S2210. On the other hand, in a case where the number of times of boundary non-matching is equal to or more than the predefined value (Yes in step S2204), the storage control device 101 specifies a connection target metadata entry by referring to an entry flag before and after boundary non-matching of the metadata entry #j (step S2205).

Next, the storage control device 101 reads a range managed by the connection target metadata entry (step S2206). The storage control device 101 resets write chunk according to boundary non-matching BC of the connection target metadata entry (step S2207).

Next, the storage control device 101 initializes the connection target metadata entry according to the reset write chunk so as to reset the metadata entry (step S2208). The specific processing content of resetting the metadata entry is the same as, for example, the content in steps S1901 to S1910 illustrated in FIG. 19, and a description thereof will be omitted.

The storage control device 101 performs a writing process on the reset write chunk according to the reset metadata entry (step S2209). Next, the storage control device 101 judges whether or not there is an unselected metadata entry which is not selected from the metadata entry groups #1 to #768 (step S2210).

Here, in a case where there is an unselected metadata entry (Yes in step S2210), the storage control device 101 returns to step S2203. On the other hand, in a case where there is no unselected metadata entry (No in step S2210), the storage control device 101 finishes a series of processes in this flowchart.

Consequently, when overwriting frequently occurs in a writing request range whose boundary does not match a range managed by a metadata entry in use, a stripe size can be dynamically changed in accordance with a size of new writing request data.

In a case where a connection target metadata entry is not specified in step S2205, the storage control device 101 skips the processes in steps S2206 to S2209. In a case where there is no unselected metadata entry in step S2210 (No in step S2210), the storage control device 101 may return to step S2201 and may repeatedly perform a series of processes in this flowchart.

As described above, according to the storage control device 101 of the embodiment, it is possible to calculate a boundary adjustment value and a stripe depth based on a writing request size and the number of data disks in response to a writing request to a volume on the RAID group 220. According to the storage control device 101, it is possible to write writing request data based on the calculated boundary adjustment value and stripe depth.

Consequently, it is possible to manage data (writing request data) which is requested to be written in the stripe unit and thus to improve writing performance of sequential I/O by reducing a write penalty.

According to the storage control device 101, it is possible to specify an address unit #i used this time from the address units #0 to #2 of the RAID group 220 based on a writing request range. According to the storage control device 101, it is possible to determine a metadata entry #j used this time from a metadata entry group in the address unit #i used this time. According to the storage control device 101, it is possible to set a start physical address, a start logical address, and the number of blocks in the metadata entry #j along with a calculated stripe depth.

Consequently, a management metadata entry for controlling access to data which is distributed and written to the respective disks (the HDD 1 to the HDD 6) can be stored in the disks. In this case, it is possible to dispose a metadata entry for managing user data near the user data.

A management metadata entry is disposed on the disk, and thus a large memory capacity is not desired. In a case of sequential I/O, an I/O request to consecutive near addresses is made. For this reason, a management metadata entry group for each address unit is read one time and is developed on the memory 212 until the I/O request to the near addresses is completed, and thus it is possible to avoid overhead for accessing to the management metadata entry. The management metadata entry is disposed near the user data, and thus it is possible to reduce disk seeking during access to the management metadata entry.

According to the storage control device 101, it is possible to determine a metadata entry #j used this time from a metadata entry group based on a reading request range in response to a reading request to a volume on the RAID group 220. According to the storage control device 101, it is possible to read reading request data based on the determined metadata entry #j. Consequently, it is possible to appropriately access data which is written in a stripe size changing depending on a size of writing request data.

According to the storage control device 101, in response to reception of a writing request with another writing request range including at least a part of a writing request range, boundary non-matching information indicating the number of times in which the writing request with another writing request range is received can be set in a metadata entry. Specifically, for example, according to the storage control device 101, the present writing request range can be divided according to a range managed by each metadata entry in use including the writing request range, and the number of times of boundary non-matching, an entry flag before and after boundary non-matching, and boundary non-matching BC can be set in the metadata entry in use.

Consequently, it is possible to count the number of times in which boundary non-matching occurs during overwriting of data to a write chunk and thus to specify the number of times in which a writing request to a writing request range whose boundary does not match a range managed by the metadata entry in use is generated.

According to the storage control device 101, in a case where the number of times of boundary non-matching of a metadata entry in use is equal to or more than a predefined value, it is possible to recalculate a boundary adjustment value and a stripe depth in accordance with a size (overwriting range X) of new writing request data. Consequently, when overwriting frequently occurs in a writing request range whose boundary does not match a range managed by a metadata entry in use, a stripe size can be dynamically changed in accordance with a size of new writing request data.

The control method described in the present embodiment may be performed by a computer such as a personal computer or a workstation executing a program which is prepared in advance. The control program is recorded on a recording medium such as a computer readable recording medium such as a hard disk, a flexible disk, a CD-ROM, an MO, or a DVD, and is read from the recording medium by the computer so as to be executed. The control program may be distributed via a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control device comprising:
a control unit that calculates a stripe depth and a size of padding data, when writing target data is distributed and written to respective data storages of a storage device with a RAID configuration, based on a size of the writing target data and a number of the data storages in response to a writing request to a volume on the storage device, and writes the writing target data based on the calculated stripe depth and the calculated size of the padding data.

2. The storage control device according to claim 1,
wherein the control unit determines metadata to be used, from management metadata groups disposed in respective regions into which a storage region of the storage device is partitioned in a predefined size, based on a writing request range of the writing target data, and sets information regarding the writing request range and the stripe depth in the determined metadata.

3. The storage control device according to claim 2,
wherein, in response to reception of another writing request with another writing request range including at least a part of the writing request range, the control unit sets, in the metadata, boundary non-matching information indicating a number of times in which the writing request with another writing request range is received.

4. The storage control device according to claim 3,
wherein, in a case where the number of times indicated by the boundary non-matching information is equal to or more than a predefined value, the control unit initializes the metadata, and calculates a stripe depth and a size of padding data for the data already written in the another writing request range, as the writing target data, to be distributed and written to respective data storages.

5. The storage control device according to claim 4,
wherein the control unit calculates a stripe depth and a size of padding data for the data already written in ranges other than the part of the writing request range as the writing target data.

6. The storage control device according to claim 2,
wherein, in response to reception of a reading request to the volume, the control unit determines metadata to be used from the metadata groups based on a reading request range of reading target data, and reads the reading target data based on the determined metadata.

7. A storage control method of causing a computer to execute:
receiving a writing request to a volume on a storage device with a RAID configuration;
calculating a stripe depth and a size of padding data, when writing target data is distributed and written to respective data storages of the storage device, based on a size of the writing target data and the number of data storages in response to the received writing request; and
writing the writing target data based on the calculated stripe depth and the calculated size of the padding data.

8. A non-transitory and computer readable storage medium storing a storage control program causing a computer to execute:
receiving a writing request to a volume on a storage device with a RAID configuration;
calculating a stripe depth and a size of padding data, when writing target data is distributed and written to respective data storages of the storage device, based on a size of the writing target data and the number of data storages in response to the received writing request; and
writing the writing target data based on the calculated stripe depth and the calculated size of the padding data.
